(19) United States
(12) Patent Application Publication
(10) Pub. No.: US 2023/0044342 A1
(43) Pub. Date: Feb. 9, 2023

(54) DETECTION OF MEMORY ACCESSES

(71) Applicant: Intel Corporation, Santa Clara, CA (US)

(72) Inventor: Hugh WILKINSON, Newton, MA (US)

(21) Appl. No.: 17/958,222

(22) Filed: Sep. 30, 2022

Related U.S. Application Data
(60) Provisional application No. 63/343,292, filed on May 18, 2022.

(51) Int. Cl. G06F 12/0882; G06F 12/0893

(52) U.S. Cl. CPC G06F 12/0882; G06F 12/0893

(57) ABSTRACT

Examples described herein relate to dynamically adjust a manner of identifying hot pages in a remote memory pool based on adjustment of parameters of a data structure. In some examples, the parameters of the data structure include a range of number of access counts and a number of pages associated with the range.

### RELATED APPLICATION

This application claims priority to U.S. Provisional Application No. 63/343,292, filed May 18, 2022. The entire contents of that application are incorporated by reference in its entirety.

### DESCRIPTION

Data can be characterized by frequency of accesses. Data can be considered cold if accessed less than a threshold number of times over a time interval. Data can be considered hot if accessed more than a second threshold number of times over the time interval. Numerous approaches perform hot and cold page tracking determine page access activity of applications and virtual machines. For example, page accesses can be determined by Accessed/Dirty (A/D) bits in page tables of applications or virtual machines (VMs), operating system (OS) induced page faults, Intel® page modification logging (PML), Intel® Processor Event-Based Sampling (PEBS), etc.

To perform cold page tracking, an OS periodically scan/clear central processing unit (CPU) A/D bits to determine page aging using memory management unit (MMU) A/D assists and TLB shootdowns. To perform hot page tracking, Linux® Memory Tiering can induce page faults by un-mapping pages to determine if page is accessed.

### BRIEF DESCRIPTION OF THE DRAWINGS

FIG. 1 depicts an example system.

FIG. 2 depicts an example system.

FIG. 3 depicts an example system.

FIG. 4 depicts an example operation of a system.

FIG. 5 depicts an example of a hot page detector (HPD).

FIG. 6 depicts an example process.

FIG. 7 depicts an example histogram.

FIG. 8 depicts an example process.

FIG. 9 depicts an example process.

FIG. 10 depicts an example computing system.

FIG. 11 depicts an example system.

### DETAILED DESCRIPTION

An interface to a memory device can perform hot page detection and report hot page addresses in a memory device (e.g., Compute Express Link (CXL) attached memory device) to a host computer. Hot page detection can utilize counters and report addresses or counts of pages that equal or exceed a threshold count considered hot. Hot page detection can occur over one or more of the following phases: configuration, histogram generation to choose a threshold count, reporting hot pages, and clearing. For one or more instance of a cycle, the configuration can be varied to attempt to improve the detection of hot pages. A processor-executed driver can utilize a histogram to determine a suitable threshold of page accesses over time to identify a hot page.

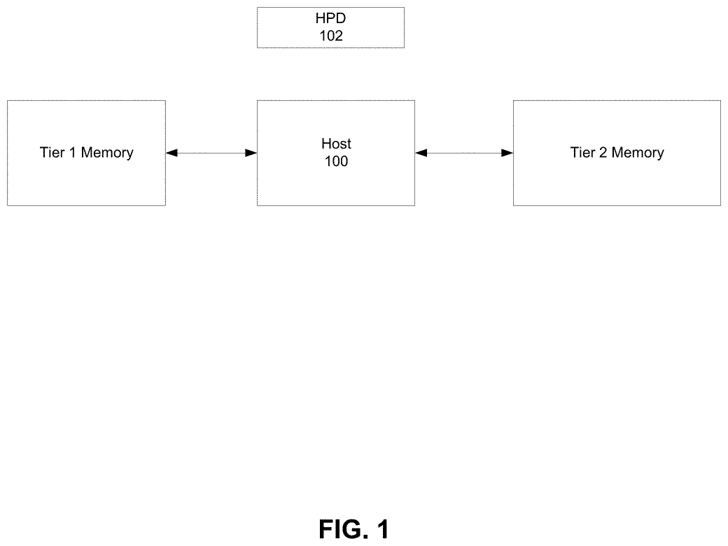

FIG. 1 depicts an example system. An example of Tier 1 memory includes Double Data Rate 5 (DDR5) attached memory. An example of Tier 2 memory can include CXL attached memory such as DDR5. Tier 1 memory can exhibit higher bandwidth and/or lower latency than that of Tier 2 memory. Data access times for commonly accessed data can be reduced by mapping data in frequently accessed virtual pages to physical pages in Tier 1 memory. For example, hot page detector (HPD) 100 can identify most frequently accessed virtual pages mapped to Tier 2 and host 102 can reallocate most frequently accessed pages from Tier 2 memory to Tier 1 memory.

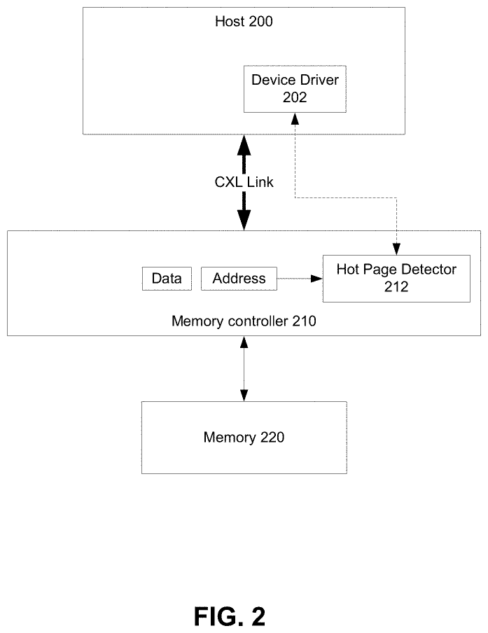

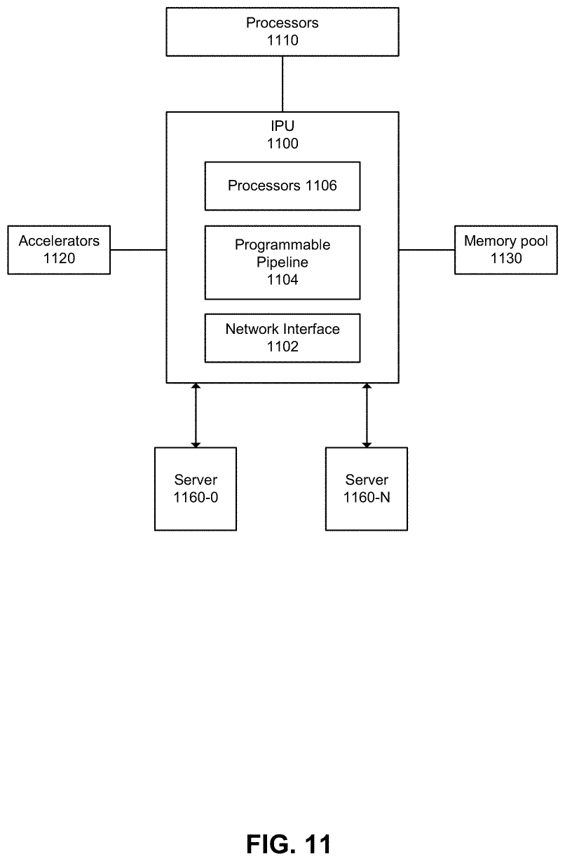

FIG. 2 depicts an example system. Host server system 200 can include processors that execute one or more processes, operating system (OS), and device driver 202. Various examples of hardware and software utilized by the host system are described at least with respect to FIG. 11 or 12. For example, processors can include a CPU, graphics processing unit (GPU), accelerator, or other processors described herein. Processes can include one or more of: application, process, thread, a virtual machine (VM), microVM, container, microservice, or other virtualized execution environment.

Driver 202 can provide processes or OS with communication to and from memory interface 210. As described herein, driver 202 can communicate with hot page detector 212 to determine a pages that are most frequently accessed (during time interval) in memory 220. Driver 202 can select ranges of counts of a histogram tracked by Hot Page Detector (HPD) 212. Histogram bucket ranges can be populated by counters of HPD 212, where a number of counters can be less than a number of pages tracked.

Host 200 can communicate with memory controller 210 using a device interface such as CXL.io over a CXL Link. Memory controller 210 can provide access to at least a CXL Type 3 Device and CXL.io and CXL.mem. See, for example, Compute Express Link (CXL) Specification version 1.1 (2020), as well as earlier versions, later versions, and variations thereof.

Memory controller 210 can provide a pooled memory controller for one or more attached hosts including host 200 for access to memory device 220. HPD 212 can be provided for one or more hosts. In some examples, HPD 210 can positioned in host 200. HPD 210 can receives write or read request from a CXL link (or other link) and translate the write or read request to a DDR5 memory write or read request. HPD 210 can receive copies of addresses in requests. HPD 212 can utilize counters to count accesses to memory addresses or pages and record a histogram of access counts. Use of allocated counters can avoid counting a same physical page more than once because counters may not be de-allocated during histogram generation. A configurable hash index can be used for mapping pages to counters to load balance counters.

HPD device driver 202 can specify a threshold number of access counts or range of counts in the histogram that can be used to assess a distribution of access counts across sampled/measured pages. HPD device driver 202 can specify a time duration or epoch to perform a count of memory accesses and histogram generation. HPD device driver 202 can deallocate counters after the time duration but not during histogram generation, to avoid double counting. In some examples, a time interval (epoch) for multiple counters can be the same, but the start of the time interval can depend on when the counter is allocated. A counter can be reported in the histogram after its time interval expires.

As described herein, HPD device driver 202 can adjust ranges of counts and/or time window size to control a number of pages that could be identified as hot. HPD 210 can send HPD device driver 202 page addresses that correspond to one or more ranges of the histogram considered hot.

Memory device 220 can include one or more of: one or more registers, one or more cache devices (e.g., level 1 cache (L1), level 2 cache (L2), level 3 cache (L3), last level cache (LLC)), one or more volatile memory device, one or more non-volatile memory device, one or more persistent memory device, dual in-line memory modules (DIMMs), or one or more of memory pools. A memory pool can be accessed as a local device or a remote memory pool through a device interface (e.g., Peripheral Component Interconnect express (PCIe)), switch (e.g., CXL), and/or network. A memory pool can be shared by multiple servers or processors. Memory device 220 can include at least two levels of memory (alternatively referred to herein as “2LM” or tiered memory) can be used that includes cached subsets of system disk level storage (in addition to, for example, run-time data). This main memory includes a first level (alternatively referred to herein as “near memory”) including lower latency and/or higher bandwidth memory made of, for example, dynamic random access memory (DRAM) or other volatile memory; and a second level (alternatively referred to herein as “far memory”) which includes higher latency and/or lower bandwidth (with respect to the near memory) volatile memory (e.g., DRAM) or non-volatile memory storage (e.g., flash memory or byte addressable non-volatile memory (e.g., Intel Optane®)). The far memory can be presented as “main memory” to the host operating system (OS), while the near memory can include a cache for the far memory that is transparent to the OS. The management of the two-level memory may be performed by a combination of circuitry and modules executed via the host central processing unit (CPU). Near memory may be coupled to the host system CPU via high bandwidth, low latency connection for low latency of data availability. Far memory may be coupled to the CPU via low bandwidth, high latency connection (as compared to that of the near memory), via a network or fabric, or a similar high bandwidth, low latency connection as that of near memory. Far memory devices can exhibit higher latency or lower memory bandwidth than that of near memory. For example, Tier 2 memory can include far memory devices and Tier 1 can include near memory.

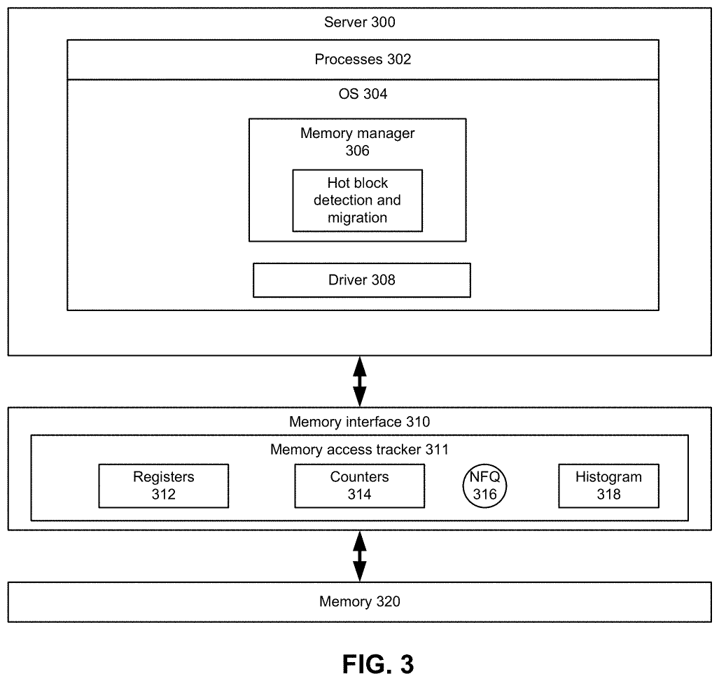

FIG. 3 depicts an example system. Server 300 can include one or more processors to execute one or more processes 302 and OS 304. In some examples, OS 304 can instead be implemented as a virtual machine manager (VM). OS 304 may access Notification Queue (NFQ) 316 and histogram data 318 to accumulate and process access data into memory manager-specific data structures to apply process-specific policies, adjust a level or threshold of accesses to data considered hot, adjust a time duration of monitoring data accesses, etc. Memory manager 306 can perform detection of or determination of a hot page threshold number in terms of number of accesses over an epoch based on histogram bin data 318 from memory interface 310. A histogram can store a distribution of pages with respect to the distribution of counts of accesses over a time duration (e.g., reads and/or writes). In some examples, different bins can include counts of accesses to different multiple spans of pages. Histogram parameters can include one or more of: address ranges to be counted, block size and threshold to be used, epoch time (e.g., counters logically count their assigned address for epoch time duration), whether read accesses are counted, whether write accesses are counted, sub-sample counting (e.g., count 1 in every X accesses), and so forth.

For example, memory manager 306 can perform migration of data stored in detected hot blocks in memory 320 from far to near memory as well as migration of cold data from near memory to far memory. In some examples, hot data can be accessed more frequently than cold data. Driver 308 can configure memory interface 310 to selectively adjust a histogram bin size and/or time duration of page measurements to attempt to isolate a range of memory page access counts that are considered to store hot data, as described herein. A hot block threshold can be set for identifying hot block addresses based on number of accesses over a time duration. In some examples, a memory page can include 4,096 bytes, although other numbers of bytes can be associated with a memory page or larger or smaller granularity of memory address ranges can be tracked (e.g., cache line).

Memory interface 310 can receive and forward read and/or write requests to memory 320 and forward responses from memory 320 (e.g., data or status) to server 300. Memory access tracker (MAT) 311 can include technologies of HPD, in some examples. HPD can include technologies of MAT 311, in some examples. MAT 311 can be in a memory access path to receive and forward read and/or write requests to memory 320. MAT 311 can identify cache misses to memory (e.g., LLC or MSC). MAT 311 can be utilized per CXL port. In some examples, OS 304 can access memory tracker 311 as a CXL.mem device.

MAT 311 can count block-granular memory accesses, where a block size could be a same as or different than system page size. MAT 311 can perform access tracking using counters 314 that count read and/or write accesses at block granularity. Memory addresses can map to counters based on one counter per block, direct mapped, set-associative, etc. MAT 311 can perform host physical address (HPA) or device physical address (DPA) based counting and reporting to memory manager 306. MAT 311 may count recent accesses in a current defined epoch

NFQ 316 can include a queue in system or device memory to share with page addresses and, optionally, counts of accesses of the hot page addresses. For example, driver 308 can configure operation of MAT 311 by writing to registers 312. Configuration of operation of MAT 311 can include specifying a size of one or more buckets in histogram (e.g., number of different pages associated with a bucket of range of access counts), access time duration over which counts of memory accesses (e.g., reads or writes) are recorded, threshold for identifying a bucket as hot, enable/disable counting of accesses, and others. Registers 312 can be implemented as memory mapped input output (MMIO) registers.

Memory interface 310 can provide server 300 with access to memory 320. Memory 320 can be implemented in a similar manner as that of memory 220.

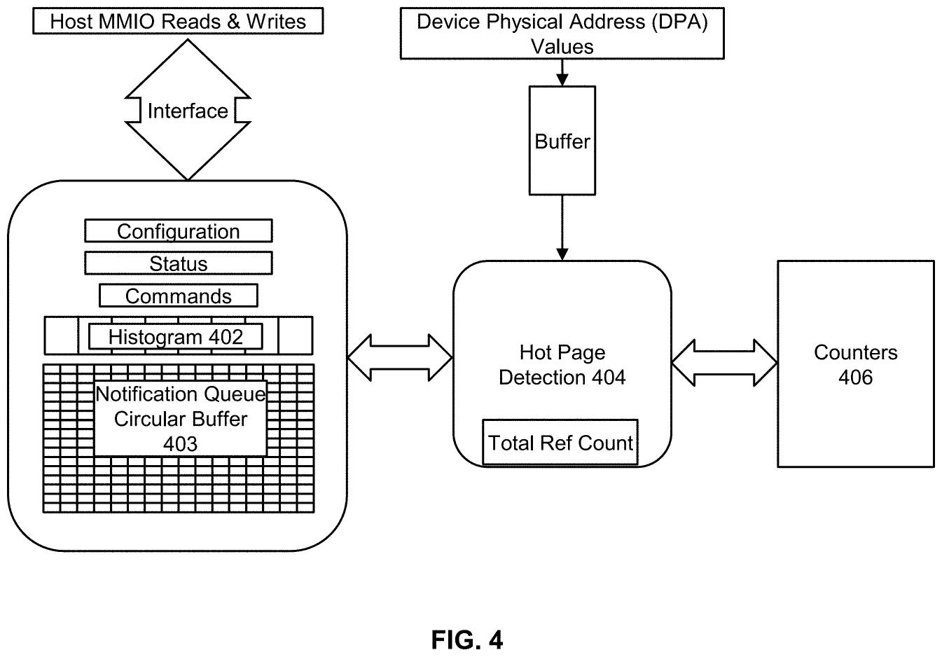

FIG. 4 depicts an example operation of a system. At (1), host processor-executed driver can configure page access count ranges of one or more buckets of histogram 402. For example, host processor-executed driver can provide a configurations of HPD 404. For example, commands can indicate start counting, stop counting, adjust configuration, and so forth. For example, status can specify one or more of: clearing, cleared, running (counting). At (2), counters 406 can collect page reference counts of device physical addresses (DPA) values associated with read or write requests to record page counts from histogram 402.

At (3), host processor-executed driver can set threshold for reporting pages as hot. For example, host-processor executed driver can provide a configuration of threshold level at which a bucket of one or more packets identified as hot. At (4), a driver can read notification queue 403 to obtain device physical address (DPA)-count pairs for counts at or above the threshold. Notification queue 403 can include addresses of pages (DPAs) identified as hot, after the hot page threshold is set for the histogram. A hot and cold page migrator or memory manager can cause migration of data in pages from a first memory device to a second memory device with lower access latency than the first memory device relative to a processor or device that is to access the data. For example, migration of data can take place from far or slower memory to faster or nearer memory such as from storage to volatile memory, volatile memory to cache, and so forth.

At (5), based at least on a number of pages associated with a hot bucket being within a range, hot page detection 404 can continue with a hot level threshold corresponding to one or more hot buckets. In some cases, where a number of pages detected as hot meets or exceeds a target level, a range of buckets can be reduced to reduce a number of pages that are part of one or more bucket(s) that is identified as hot. In some examples, ranges of the histogram can be non-uniform. For example, a bucket range of counts can be adjusted to be reduced in number of counts so that a bucket identified as hot can be divided into more buckets to more finely divide a number of pages that are associated with a hot bucket. After host page threshold count is set and histogram generation and analysis, the processor-executed driver can access queue 403, which can report access counts for one or more pages associated with a hot bucket as well as associated DPAs. Thereafter, hot page detector 404 can build histogram data based on adjusted bucket ranges.

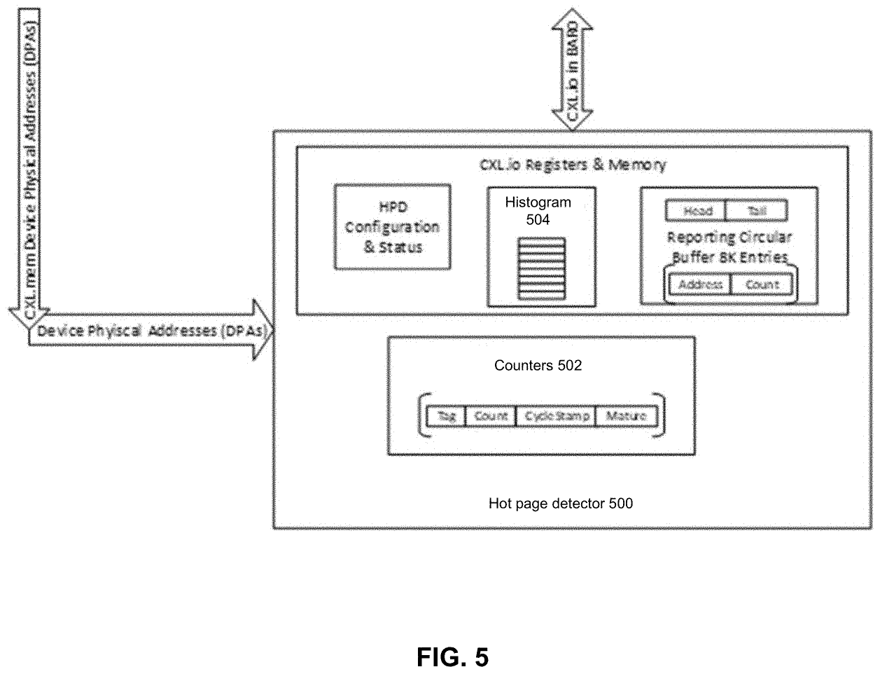

FIG. 5 depicts an example of a hot page detector (HPD). HPD 500 can be positioned in a CXL bridge or in host CXL controller (e.g., host CXL bridge). HPD 500 can translate CXL type 3 host physical addresses (e.g., memory buffer address) to memory device physical address. HPD 500 can utilize counters 502 to perform counting of accesses to pages mapped to bins of a histogram. For example, for 64K pages, 64K counters (or other number) can track accesses to pages. For example, entries in counters 502 can be accessed by a hash of device physical address (DPA).

In an entry in counters 502, the following Table 1 provides examples of data in a counter.

TABLE 1

| Field | Example data |
|---|---|
| Tag | Identify a page (e.g., bits 40-28 of device |
| | physical address (DPA)) |
| Count | Store a number of times page accessed during |
| | time of observations. Count can saturate if it |
| | reaches max value. |
| CycleStamp | Record when counter was allocated (time |
| | window). |
| Mature | Indicate whether a counting interval expired. |

Histogram data 504 can include two or more bins of groupings of different pages. A server-executed driver can set configuration and status of HPD 500 to specify at least bin sizes or bucket ranges (e.g., number of access counts associated with one or more bins) and time duration of measurement of accesses. Driver can provide HPD 500 with commands or register updates to start or stop building of histogram. In some examples, the driver does not access data of counters 502 but accesses histogram data 504 indicative of counts of memory accesses and corresponding numbers of pages. The driver can access circular buffer of reported addresses generated by HPD 500 to access detected hot page DPAs. In some examples, CXL.io or PCIe links can be utilized for communication between driver and HPD 500.

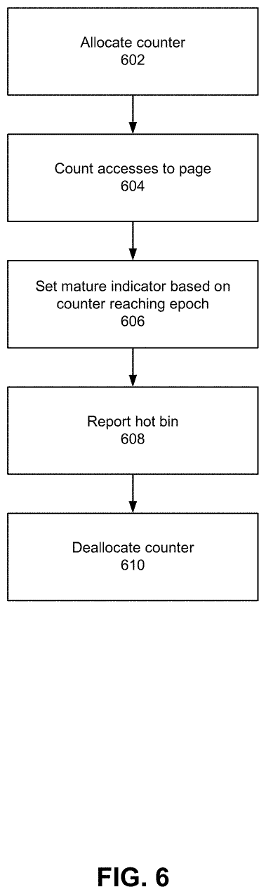

FIG. 6 depicts an example process. The process can be performed by a hot page detector or a memory interface. At 602, data in a counter can be set. For example, an address tag can be set to identify a page mapped to a counter a count can be set to 1, CycleStamp can be set to a current time stamp value, and the mature flag can be set to 0. At 604, accesses to the page can be counted. A time stamp value can be compared against a current time stamp to determine an age of a count and whether an epoch has been reached. A current time stamp value can increment while accesses to the page are counted. At 606, based on an age of the counter matching a configured epoch value that specifies a time duration to count accesses to one or more pages, a mature flag can be set in counter entry to indicate a count is completed or exhausted. Counting accesses using the counter can be stopped. Data in the counter set can be read by a host. At 608, histogram bin count data can be conditionally reported to host or read by a host via NFQ based on a count for a bin exceeding a threshold level of hotness such that the bin of one or more pages is identified as hot. At 610, the histogram generation can continue until a hot page threshold is set. In some examples, no counters are de-allocated until the hot page threshold is set. If a hot page threshold is not derived from the histogram, then the HPD can be cleared, the histogram re-configured, and another histogram is generated with initial or default ranges.

Example pseudocode of operations 606 to 610 can be as follows.

```
while (!MatureCount || HotRefCount == 0);
  if (PageRefCount >= HotRefCount)
    {while (!HostAvail); ReportToHost( ); }
  DeallocateCounter( );
```

After counting for epoch duration or longer, driver can access count distribution of blocks. Driver can determine whether to adjust a size of ranges based on number of pages in upper ranges, as described herein.

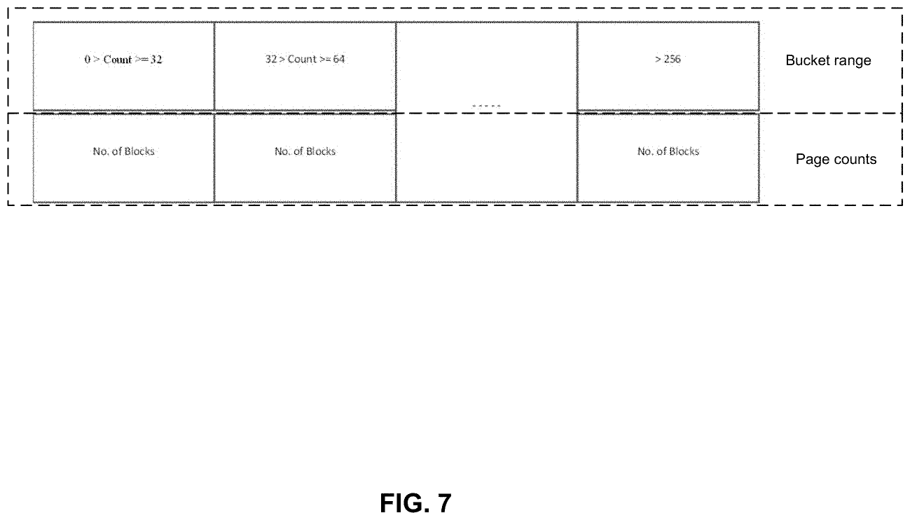

FIG. 7 depicts an example histogram. Histogram bucket ranges can correspond to ranges of counts. In some examples, a first bucket can record a number of blocks with number of accesses between 0 and 32, a second bucket can record a number of accesses between 33 to 64, and Nth bucket can record a number of accesses greater than 256.

Kernel software or HPD driver can adjust bucket range size based on histogram data. For example, a bucket range size can be increased to increase a number of blocks considered hot. For example, bucket range size can be decreased to decrease a number of blocks considered hot. For example, a target histogram format can provide 10% of pages in an upper bucket of counts. If a percentage of pages in upper bucket deviates from such target percentage of pages in the upper bucket, kernel software or HPD driver can adjust histogram interval to be smaller or larger or change histogram upper and lower limits.

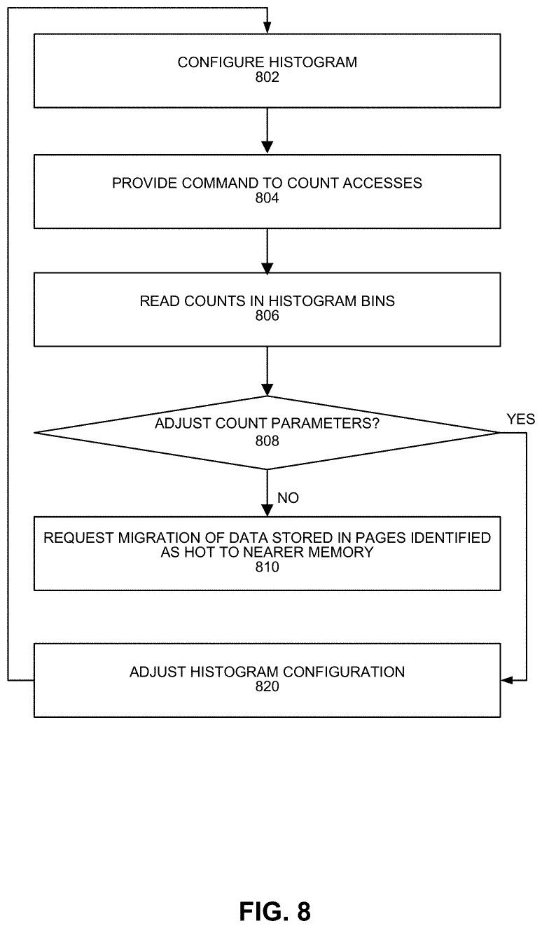

FIG. 8 depicts an example process to adjust a histogram. In some examples, the process can be performed by a server processor-executed driver, state machine in an HPD, or other software or device. At 802, a configuration of a histogram or other data structure utilized to record numbers of pages associated with different ranges of access counts. For example, a memory interface can be configured with ranges of access counts as well as lower and upper limits of different ranges. Ranges can grow exponentially (e.g., 32, 64, 128, 256, 512, 1024, 2048 and 32767), or another manner (e.g., increase by multiples, logarithmic increase). The configuration can include a hash index configuration to identify an index to attempt to load balance counters of accesses.

At 804, a command to count accesses can be issued. For example, the command can cause counting of accesses to memory page regions (or other sizes) and associating the counts with a range or bin of the histogram. At 806, numbers of pages associated with different histogram ranges can be read. At 808, based on the numbers of pages associated with different histogram ranges, a determination can be made to adjust histogram range size. For example, if more than a threshold number of pages or percentage of pages monitored are allocated to one or more upper buckets (e.g., higher number of access counts), at 820, a size of one or more access count ranges can be increased to decrease a number of pages identified for migration. For example, if a percentage of pages in one or more upper buckets is more than 5 or 10% or other values, then a size and/or floor of an upper bucket can be increased to attempt to decrease a number of pages identified as hot to reduce a number of pages identified for migration. Increases can be exponential or multiples. For example, if less than the threshold number of pages or percentage of pages monitored are allocated to one or more upper buckets (e.g., higher number of access counts), at 820, one or more floors of buckets can be decreased to attempt to increase a number of pages identified as hot. For example, if a percentage of pages in one or more upper buckets is less than 10% or other values, then a size and floor of top bucket can be decreased. Decreases can be exponential or multiples.

In some examples, at 820, a time epoch of counting accesses can be decreased based on higher rate of memory accesses to pages. In some examples, at 820, a time epoch of counting accesses can be increased based on lower rate of memory accesses to pages. In some examples, a distribution of formerly recorded counter data based on updated histogram configurations can occur and 808 can follow to determine if parameters are to be adjusted again or provide an acceptable number of pages to migrate. In some examples, counter data can be recorded for another epoch based on updated histogram configurations can occur and 808 can follow to determine if parameters are to be adjusted again or provide an acceptable number of pages to migrate.

However, if a number of pages or percentage of pages monitored are allocated to one or more upper buckets is at or above the threshold number of pages or percentage of pages, the number of hot pages can be an accepted number identified for migration and at 810, page addresses associated with hot pages can be identified by an HPD to the driver so that data in the hot page addresses can be migrated to higher bandwidth and/or lower latency memory. Accordingly, accesses to one or more buckets of pages as opposed to counts of monitored pages can be provided to reduce an amount of data made available to the driver for use to identify data to migrate. For example, merely numbers and/or addresses of hot pages can be identified to determine which data to migrate to lower latency memory. For example, reported pages can include pages associated with at least one hot bucket of the one or more buckets of the histogram and subsequent pages with access counts within a range of the at least one hot bucket of the one or more buckets. HPD can report an overall count of pages or counts of buckets so that driver can determine a percentage of pages that are considered hot pages. For example, a driver or state machine in HPD (e.g., memory interface at a CPU, memory device interface, and memory device) can determine what data to migrate and cause migration of data. In some examples, software executing on a host can determine what data to evict from near lower latency memory (e.g., cold pages or pages accessed less than a threshold number of times over a time interval).

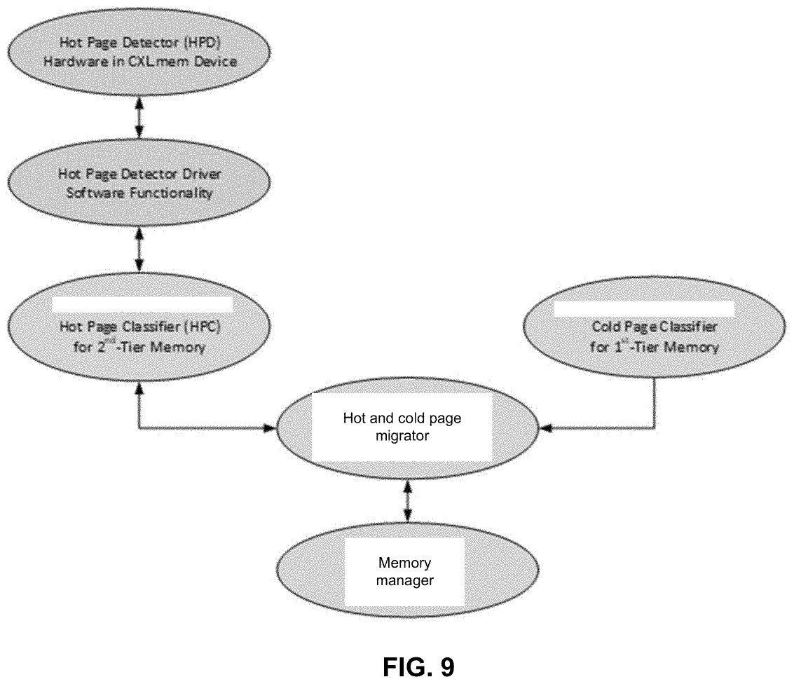

FIG. 9 depicts a process for Hot Page Detector (HPD) to identify candidate Tier-2 pages for migration to Tier-1 memory (e.g., lower latency memory). Monitoring of hot pages can occur for one or more particular workloads or across multiple workloads that access a range of pages. For example, HPD hardware device in a CXL bridge or in host CXL controller can generate a histogram of access counts for bucket ranges of counts. Host HPD driver executing on a host can read number of blocks or pages accessed per bucket ranges of counts. In some cases, HPD hardware device can report page address and counts of accesses when for pages associated with access counts that equal or exceed a threshold level as configured by the HPD driver. Kernel software can receive histogram data from HPD driver and classify pages as hot or cold based on OS specifications. Kernel software can determine whether to adjust range and/or time window of histogram data measurement by HPD hardware. Kernel software can cause of migration of data in cold pages from Tier 1 memory to Tier 2 memory and/or migration of hot data from Tier 2 memory to Tier 1 memory. A memory manager in the host or HPD hardware device can perform page migration.

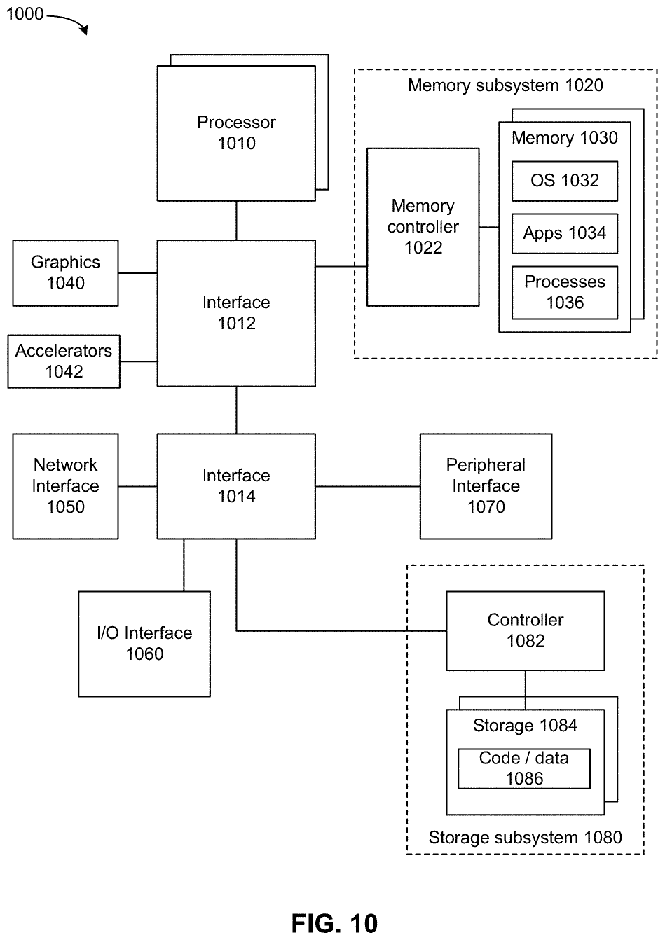

FIG. 10 depicts an example computing system that can be used in a server or data center. Components of system 1000 (e.g., processor 1010, interface 1012, memory controller 1022, memory 1030, I/O interface 1060, controller 1086, and so forth) to perform operations to determine hot and cold pages based on ranges of access counts and adjust range sizes, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 1032 can enable or disable circuitry to perform operations to determine hot and cold pages based on ranges of access counts and adjust range sizes, as described herein

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers, memory pools, or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can perform operations to update mappings of received packets to target processes or devices can be updated, as described herein.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. An example of a volatile memory include a cache. A non-volatile memory (NVM) device is a memory whose state is determinate even if power is interrupted to the device.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

FIG. 11 depicts an example system. In this system, IPU 1100 manages performance of one or more processes using one or more of processors 1106, processors 1110, accelerators 1120, memory pool 1130, or servers 1140-0 to 1140-N, where N is an integer of 1 or more. In some examples, processors 1106 of IPU 1100 can execute one or more processes, applications, VMs, containers, microservices, and so forth that request performance of workloads by one or more of: processors 1110, accelerators 1120, memory pool 1130, and/or servers 1140-0 to 1140-N. IPU 1100 can utilize network interface 1102 or one or more device interfaces to communicate with processors 1110, accelerators 1120, memory pool 1130, and/or servers 1140-0 to 1140-N. IPU 1100 can utilize programmable pipeline 1104 to process packets that are to be transmitted from network interface 1102 or packets received from network interface 1102. Programmable pipeline 1104 and/or processors 1106 can be configured to perform operations to determine hot and cold pages based on ranges of access counts and adjust range sizes, as described herein.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”′

Illustrative examples of the devices, systems, and methods disclosed herein are provided below. An embodiment of the devices, systems, and methods may include one or more, and combination of, the examples described below.

Example 1 includes one or more examples and an apparatus comprising: a memory interface comprising circuitry to: based on a first configuration, provide a number of pages with access counts within one or more buckets of a histogram, wherein at least one of the one or more buckets of the histogram is associated with a configured access count range and a number of pages is associated with the access count range and based on a second configuration, adjust the configured access count range of the one or more buckets based on a received command.

Example 2 includes one or more examples, wherein a processor-executed driver or state machine circuitry is to provide the at least one configuration.

Example 3 includes one or more examples, wherein the adjusted configured access count range comprises an adjusted access count range size corresponding to a hot access count range.

Example 4 includes one or more examples, wherein the adjusted configured access count range comprises a decreased access count range corresponding to a hot access count range.

Example 5 includes one or more examples, wherein the circuitry is to: based on a third configuration, adjust a duration of time of determination of the number of pages with access counts within the one or more buckets of a histogram.

Example 6 includes one or more examples, wherein the circuitry is to: report merely pages associated with a hot bucket of the one or more buckets of the histogram to a memory manager and count of pages associated with monitored accesses.

Example 7 includes one or more examples and includes circuitry to: migrate data associated with the pages associated with a hot bucket of the one or more buckets of the histogram to a memory device with lower access latency and/or bandwidth than a memory device that stores the data.

Example 8 includes one or more examples, wherein the memory interface is to provide access to a memory device in a manner consistent at least with Compute Express Link (CXL).

Example 9 includes one or more examples and includes at least one memory device coupled to the memory interface.

Example 10 includes one or more examples and includes a server coupled to the memory interface, wherein the server is to access the at least one memory device by the memory interface.

Example 11 includes one or more examples, wherein the memory interface comprises circuitry is to migrate data associated with the pages associated with a hot bucket of the one or more buckets of the histogram to a memory device with higher bandwidth and/or lower access latency that a memory device that stores the data and comprising a data center comprising the server and a second memory device, wherein data from the memory device is to be migrated from the memory device to the second memory device.

Example 12 includes one or more examples and includes at least one non-transitory computer-readable medium comprising instructions stored thereon, that if executed by one or more processors, cause the one or more processors to: execute a device driver to configure circuitry in a memory interface to: provide a number of pages of a memory device with access counts within one or more buckets of a histogram, wherein at least one of the one or more buckets of the histogram is associated with a configured access count range and a number of pages is associated with the access count range and report pages associated with at least one hot bucket of the one or more buckets of the histogram.

Example 13 includes one or more examples and includes instructions stored thereon, that if executed by one or more processors, cause the one or more processors to: identify a level of access counts of the hot bucket.

Example 14 includes one or more examples and includes instructions stored thereon, that if executed by one or more processors, cause the one or more processors to: cause migration of at least a portion of data in the reported pages of the memory device to a second memory device, wherein the second memory device has a lower access latency than that of the memory device.

Example 15 includes one or more examples and includes instructions stored thereon, that if executed by one or more processors, cause the one or more processors to: adjust the configured access count range of the one or more buckets.

Example 16 includes one or more examples and includes instructions stored thereon, that if executed by one or more processors, cause the one or more processors to: adjust a duration of time of determination of the number of pages with access counts within the one or more buckets of a histogram.

Example 17 includes one or more examples and includes a method comprising: adjusting at least one range of counts of accesses to a first memory device in a histogram and causing migration of data from the first memory device to a second memory device based on reporting of merely pages associated with a hot bucket of one or more buckets of the histogram.

Example 18 includes one or more examples, wherein the adjusting at least one range of counts of accesses to the first memory device comprises adjusting at least one range of counts of accesses to the first memory device to identify a range of hot pages.

Example 19 includes one or more examples, wherein a memory interface device performs the adjusting at least one range of counts of accesses to a first memory device.

Example 20 includes one or more examples, wherein a memory interface device and/or server performs the causing migration of data from the first memory device to a second memory device based on reporting of merely pages associated with a hot bucket of one or more buckets of the histogram and a hot page count level based on a configured hot bucket access count range.

Example 21 includes one or more examples, and includes at least one non-transitory computer-readable medium comprising instructions stored thereon, that if executed by one or more processors, cause the one or more processors to: dynamically adjust a manner of identifying hot pages in a remote memory pool based on adjustment of parameters of a data structure.

Example 22 includes one or more examples, wherein the parameters of the data structure include a range of number of access counts and a number of pages associated with the range.

1. An apparatus comprising:
a memory interface comprising
circuitry to:
based on a first configuration, provide a number of pages with access counts within one or more buckets of a histogram, wherein at least one of the one or more buckets of the histogram is associated with a configured access count range and a number of pages is associated with the access count range and
based on a second configuration, adjust the configured access count range of the one or more buckets based on a received command.

2. The apparatus of claim 1, wherein a processor-executed driver or state machine circuitry is to provide the at least one configuration.

3. The apparatus of claim 1, wherein the adjusted configured access count range comprises an adjusted access count range size corresponding to a hot access count range.

4. The apparatus of claim 1, wherein the adjusted configured access count range comprises a decreased access count range corresponding to a hot access count range.

5. The apparatus of claim 1, wherein the circuitry is to:
based on a third configuration, adjust a duration of time of determination of the number of pages with access counts within the one or more buckets of a histogram.

6. The apparatus of claim 1, wherein the circuitry is to:
report merely pages associated with a hot bucket of the one or more buckets of the histogram to a memory manager and count of pages associated with monitored accesses.

7. The apparatus of claim 6, comprising circuitry to:
migrate data associated with the pages associated with a hot bucket of the one or more buckets of the histogram to a memory device with lower access latency and/or bandwidth than a memory device that stores the data.

8. The apparatus of claim 1, wherein the memory interface is to provide access to a memory device in a manner consistent at least with Compute Express Link (CXL).

9. The apparatus of claim 1, comprising at least one memory device coupled to the memory interface.

10. The apparatus of claim 9, comprising a server coupled to the memory interface, wherein the server is to access the at least one memory device by the memory interface.

11. The apparatus of claim 10, wherein the memory interface comprises circuitry is to migrate data associated with the pages associated with a hot bucket of the one or more buckets of the histogram to a memory device with higher bandwidth and/or lower access latency that a memory device that stores the data and comprising a data center comprising the server and a second memory device, wherein data from the memory device is to be migrated from the memory device to the second memory device.

12. At least one non-transitory computer-readable medium comprising instructions stored thereon, that if executed by one or more processors, cause the one or more processors to:
execute a device driver to
configure circuitry in a memory interface to:
provide a number of pages of a memory device with access counts within one or more buckets of a histogram, wherein at least one of the one or more buckets of the histogram is associated with a configured access count range and a number of pages is associated with the access count range and
report pages associated with at least one hot bucket of the one or more buckets of the histogram.

13. The computer-readable medium of claim 12, comprising instructions stored thereon, that if executed by one or more processors, cause the one or more processors to:
identify a level of access counts of the hot bucket.

14. The computer-readable medium of claim 12, comprising instructions stored thereon, that if executed by one or more processors, cause the one or more processors to:
cause migration of at least a portion of data in the reported pages of the memory device to a second memory device, wherein the second memory device has a lower access latency than that of the memory device.

15. The computer-readable medium of claim 12, comprising instructions stored thereon, that if executed by one or more processors, cause the one or more processors to:
adjust the configured access count range of the one or more buckets.

16. The computer-readable medium of claim 12, comprising instructions stored thereon, that if executed by one or more processors, cause the one or more processors to:
adjust a duration of time of determination of the number of pages with access counts within the one or more buckets of a histogram.

17. A method comprising:
adjusting at least one range of counts of accesses to a first memory device in a histogram and
causing migration of data from the first memory device to a second memory device based on reporting of merely pages associated with a hot bucket of one or more buckets of the histogram.

18. The method of claim 17, wherein the adjusting at least one range of counts of accesses to the first memory device comprises adjusting at least one range of counts of accesses to the first memory device to identify a range of hot pages.

19. The method of claim 17, wherein a memory interface device performs the adjusting at least one range of counts of accesses to a first memory device.

20. The method of claim 17, wherein a memory interface device and/or server performs the causing migration of data from the first memory device to a second memory device based on reporting of merely pages associated with a hot bucket of one or more buckets of the histogram and a hot page count level based on a configured hot bucket access count range.

21. At least one non-transitory computer-readable medium comprising instructions stored thereon, that if executed by one or more processors, cause the one or more processors to:
dynamically adjust a manner of identifying hot pages in a remote memory pool based on adjustment of parameters of a data structure.

22. The computer-readable medium of claim 21, wherein the parameters of the data structure include a range of number of access counts and a number of pages associated with the range.
